(19) United States
(12) Patent Application Publication
(10) Pub. No.: US 2005/0025183 A1
(43) Pub. Date: Feb. 3, 2005

(54) Network traffic data processing system and method for auto-configuration of a router

(75) Inventors: Damien Galand, Chaville (FR); Philippe Bereski, Morsang Sur Orge (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/901,170

(22) Filed: Jul. 29, 2004

(30) Foreign Application Priority Data
Aug. 1, 2003 (FR) 03 09 507

(51) Int. Cl. H04J 3/22

(52) U.S. Cl. 370/469; 370/252

(57) ABSTRACT

A data processing system is disclosed for a communication router having a layered architecture comprising at least one physical layer connected by at least one connection to at least one communication network and placed immediately under at least one data link layer which is itself placed immediately under at least one network layer. The data processing system comprises processors in each data link layer to analyze traffic data from each network reaching a physical layer via each of its connections and to determine configuration data for configuring the network layer concerned from the network traffic data. There is at least one application programming interface between the data link layer concerned and the network layer concerned, independent of each network technology and able to transfer the particular configuration data to the network layer concerned so that it is configured as a function of each network traffic.

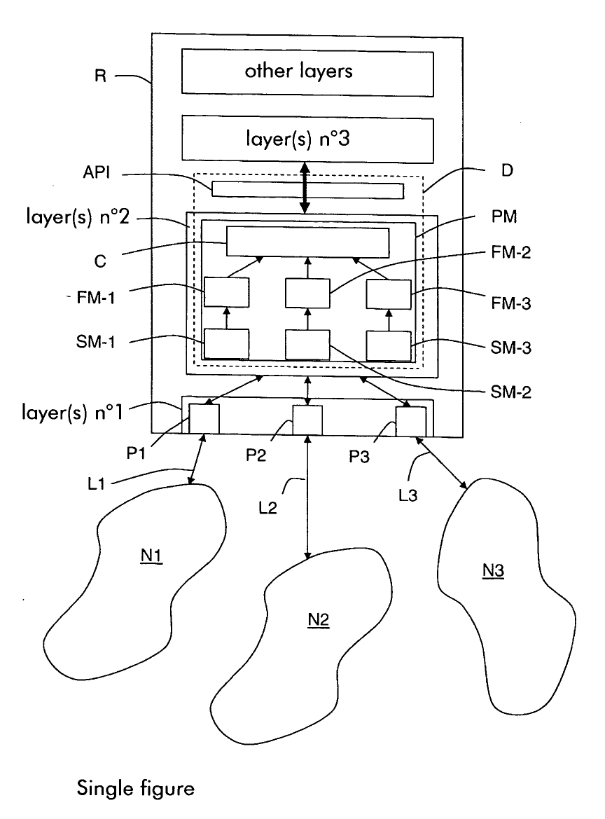

### CROSS-REFERENCE TO RELATED APPLICATIONS

This application is based on French Patent Application No. 03 09 507 filed Jan. 08, 2003, the disclosure of which is hereby incorporated by reference thereto in its entirety, and the priority of which is hereby claimed under 35 U.S.C. § 119.

### BACKGROUND OF THE INVENTION

1. Field of the invention

The field of the invention is that of communication networks and to be more precise that of configuring routers of such networks.

2. Description of the prior art

A router is a unit constituting a network node and whose architecture is divided into seven layers in the Open System Interconnection (OSI) model. The seven layers are in a hierarchical relationship, each layer using information from the underlying layer (lower level) and supplying a service to the overlying layer (higher level).

Starting from the lowest level, the seven layers are usually called the physical layer (1), the data link layer (2), the network layer (3), the transport layer (4), the session layer (5), the presentation layer (6), and the application layer (7).

Some routers, such as IP routers, for example, are connected to a plurality of data networks using different versions of the Internet Protocol and/or implementing different types of services and/or using different communication hardware, and their data link layer (layer 2) is therefore dependent on different network technologies, although their network layer (layer 3) is independent of those technologies. Consequently, the network layer of the router must be configured so that it is able to use information from the data link layer efficiently.

At present, the network layer of the routers is configured remotely via a network management platform. Because networks are constantly evolving, network supervisors must constantly reconfigure their routers, which is a lengthy and fastidious process, in particular because of the large number of routers in each network, and consumes resources unnecessarily.

Thus one object of the invention is to remedy this drawback.

### SUMMARY OF THE INVENTION

To this end the invention proposes a method of processing data for a communication router having a layered architecture comprising at least one physical layer connected by at least one connection to at least one communication network and placed immediately under at least one data link layer in turn placed immediately under at least one network layer, which methods consists in: i) analyzing at the level of a data link layer data traffic from each network reaching a physical layer via each of its connections, ii) determining configuration data for the network layer concerned from the network traffic data, and iii) configuring the network layer concerned on the basis of the configuration data as a function of the traffic of each network.

In other words, each router is autoconfigured as a function of traffic data that it receives at the level of its physical layer or layers.

According to another feature of the invention, the configuration is effected by transferring the configuration data to the network layer concerned via at least one application programming interface between the data link layer and the network layer and independent of each network technology.

Data depending on each network technology implemented by the data link layer concerned is preferably determined from the network traffic data information, after which the information data is converted into configuration data independent of each network technology (in order to guarantee reuse of the API interface). In this case, it is advantageous If the network traffic data reaching the physical layer via each of its network connections is observed independently and information data depending on the network technology associated with each network connection is extracted from the traffic data. It is important to note that a network connection can transport simultaneously several types of level 2 (data link layer) data and that, because of this, a plurality of network technologies may be in transit on the same connection. Extracted information data (which corresponds to each traffic) may then be bundled and conformed in accordance with a selected format. Finally, the bundled information data may be converted and conformed to yield configuration data independent of each network technology.

The traffic data is preferably analyzed periodically so that each network layer may be configured periodically. However, the traffic data being analyzed on receiving a dedicated notification on one of the connections may also be envisaged.

Moreover, the configuration data that is determined and transferred to a network layer comprises, for example, the maximum transmission unit (MTU) size, the different versions of the network layer protocol used within each network to which the physical layer of the router is connected (such as IPv4, IPv6, Decnet, Appletalk, IPX, etc.), the various network layer service versions used in each network to which a physical layer of the router is connected (such as different routing protocols), and the network layer addresses of routers adjoining the router and to which a physical layer is connected.

The invention also proposes a data processing system for a communication router having a layered architecture comprising at least one physical layer connected by at least one connection to at least one communication network and placed immediately under at least one data link layer which is itself placed immediately under at least one network layer, which system comprises processing means implemented in each data link layer and adapted to analyze traffic data from each network reaching a physical layer via each of its connections and to determine configuration data for configuring the network layer concerned from the network traffic data, and at least one application programming interface between the data link layer concerned and the network layer concerned, independent of each network technology and adapted to transfer the particular configuration data to the network layer concerned so that it is configured as a function of each network traffic.

The processing means are preferably adapted to determine information data depending on each network technology implemented by the data link layer concerned from the network traffic data and then to transform the information data into configuration data independent of each network technology. In this case, it is advantageous if the processing means include the same number of surveillance modules as the number of network connections of each physical layer, each surveillance module being adapted to observe the network traffic data reaching the physical layer concerned via one of its network connections and to extract from the latter the information data depending on the network technology associated with the network connection.

Alternatively, there may be envisaged the use of the same surveillance module to process all the connections of the same type of physical layer by maintaining separate data structures for each physical interface, for example by using the “multithread” technique.

Moreover, it is then preferable if the processing means include the same number of formatting modules as the number of network connections of each physical layer, each formatting module being associated with a surveillance module and adapted to bundle the information data extracted by the associated surveillance module and to conform the bundled information data in accordance with a selected format. Alternatively, using the same shaping module connected to the surveillance module processing all the connections of the same type of physical layer may be envisaged. Furthermore, the processing means may comprise a conversion module connected to each formatting module and to the application programming interface concerned and adapted to convert the bundled and conformed information data into configuration data independent of each network technology.

The invention also provides a communication router equipped with a processing device of the type described hereinabove.

The invention is particularly well adapted, although not exclusively so, to Internet Protocol (IP) communication networks.

Also, the processing means are preferably adapted to perform the analyses periodically so that each network layer may be configured periodically. However, it may equally be envisaged that the processing means are adapted to carry out an analysis on receiving a dedicated notification on one of the connections.

### BRIEF DESCRIPTION OF THE DRAWING

Other features and advantages of the invention will become apparent on examining the following detailed description and the appended drawing, in which the single figure shows diagrammatically one embodiment of a router equipped with a processing device of the invention and connected to three communication networks. The appended drawing constitutes part of the description of the invention and may, if necessary, contribute to the definition of the invention.

### DETAILED DESCRIPTION OF THE PREFERRED EMBODIMENT

An object of the invention is to enable autoconfiguration of a communication router by analyzing the traffic that it receives.

As shown in the single figure, a communication router R has an Open System Interconnection (OSI) architecture that comprises seven hierarchically related layers.

At the lowest level there are one or more physical layers 1, followed by data link layer(s) 2, and then network layer(s) 3, and then the other layers, including the transport layer 4, the session layer 5, the presentation layer 6, and the application layer 7 (this is the layer at the highest level). This architecture and the seven layers that constitute it are well known in the art and so are not described here. Suffice to say that each physical layer 1 and each data link layer 2 are dependent on the technologies of the networks to which they are connected, whereas each network layer 3 is independent of the network technologies.

A router R of the above kind is generally connected to a plurality of communication networks Ni, of which it constitutes a node. In the example shown, the router R is connected by three physical ports P1 to P3 to three communication networks N1 to N3. For example, these three communication networks are IP data networks, which may use different network layer protocol versions, such as IPv4, IPv6, Decnet, and/or different network layer service versions, such as different routing protocols.

If the networks to which the router R is connected by its physical ports Pi associated with its physical layer(s) 1 are IP networks, the router is called an IP router. Hereinafter it is considered by way of illustrative example that the router R is an IP router and has only one physical layer and one data link layer. However, the router could be of a type other than the IP type and/or incorporate a plurality of physical layers and/or a plurality of data link layers.

To allow fast adaptation of the router R to evolving IP networks Ni to which it is connected with no remote or local external intervention, the invention proposes to equip it with a processing device D.

To this end, the device D comprises processing means PM implemented in the data link layer 2 and one or more application programming interfaces (API) interleaved between the data link layer and the (or each) network layer 3.

Although this does not appear in the single figure, a plurality of network layers 3 may coexist within a router R, and in this case there are preferably as many application programming interfaces as there are network layers. This enables the router R to operate in multiprotocol mode.

The processing means PM are adapted to analyze the data (or data frames) of traffic on each network that reaches the three physical ports Pi associated with the physical layer 1 via each of its network connections Li and to determine configuration data for the network layer 3 from that network traffic data.

To be more precise, packets are received with a layer 2 header and payload which in turn contain a level 3 header and payload. The nature of layer 3 is determined by a special code in the header of the layer 2 packet, for example a code equal to 0×0800 for IPv4 or 0×86DD for IPv6 when it is transported by an Ethernet type layer 2. Once the nature of the layer 3 frame is known, the specific information of that layer 3 may in turn be examined in the layer 3 header, for example “protocol code 1” for ICMP in IPv4 or “value 58 of NextHeader” for ICMP in IPv6.

Each application programming interface is responsible for transferring the configuration data determined by the processing means PM from the data link layer 2 to the network layer 3 to which it is connected, so that the latter is configured as a function of the traffic of the various networks that the router R receives.

Thanks to the processing device D, each router R may effect its own configuration as a function of the data traffic (or data frames) that it receives at the level of its physical layer 1.

The traffic data is preferably analyzed periodically, for example every five minutes. In this case, the network layer is reconfigured at the same period. Triggering the analysis of the data traffic on receiving a dedicated notification on a connection Li may equally be envisaged.

In one particularly advantageous embodiment, as shown in the single figure, the processing means PM comprise three surveillance modules SM-i each associated with one of the three physical ports Pi and connected to respective formatting modules FM-i which are themselves connected to a conversion module CM.

Each surveillance module SM-i is adapted to observe the network traffic data (or frames) received by one of the physical ports Pi in order to extract therefrom information data that they contain that is useful for configuring the network layer 3 and that depends on the network technology that is implemented by the data link layer 2 and is associated with the connection Li between said port Pi and the network Ni.

For example, the extracted information data consists of the characteristics of the routers placed “at the ends” of the connections (or links) Li. These characteristics are used to configure the router appropriately.

Each formatting module FM-i receives from the surveillance module FM-i to which it is connected the data that the latter has extracted, in order to bundle the data (it may receive bursts of information that it is then useful to bundle in order to present to the next higher layer only what is really useful), and then to conform it (or format it) in accordance with a selected format, for example the XML or ASN1 format (although any other appropriate type of format may be envisaged).

The data bundled and conformed by each formatting module FM-i and depending on the network technologies implemented by the data link layer 2 feeds the conversion module CM, which is responsible for converting (or transforming) it into configuration data independent of the network technologies and needed by the network layer 1 for its autoconfiguration.

For example, the configuration data is representative of the maximum transmission unit (MTU) size or different network layer protocol versions that are used in the different networks Ni (IPv4, IPv6, Decnet, and the like), or the different network layer service versions used within the different networks Ni (different routing protocols, different RSVP, LDP and like signaling), or network layer addresses of adjacent routers (this may in particular enable the router R to observe routing—for example, the data link layer may generate ARP requests to obtain their IPv4 (or IPv6) addresses from the adjacent routers on each connection Li.

The conversion module CM is connected to the application programming interface API that is responsible for transferring the configuration data to the network layer concerned and is independent of the layer 2 technology.

On receiving this configuration data, the network layer 3 concerned is then able to configure itself in the conventional way, thereby enabling higher layer services to be given information on the data, for example the MTU size. The router R is then adapted to the traffic that it receives from the three IP networks Ni to which it is connected by its physical ports Pi, until the next modification on one of the networks Ni detected in subsequent analyses.

The processing device D of the invention, and in particular its surveillance modules SM-i, its formatting modules FM-i, its conversion module CM and each of its application programming interfaces API, may be implemented in the form of electronic circuits, data processing modules (software), or a combination of circuits and software.

It is important to note that a variant may be envisaged in which the same surveillance module is used to process all the connections of the same type of physical layer. It is then necessary to maintain separate data structures for each physical interface, for example using the multithread technique. In this case, the same formatting module is preferably connected to the surveillance module used to process all the connections of a common physical layer type.

The invention also provides a method of processing data for a communication router R having a layered architecture.

The latter method may in particular be implemented with the aid of the processing device D and the communication router R described hereinabove. The main and optional functions and subfunctions of the steps of the method being substantially identical to those of the means constituting the processing device D and/or the communication router R, only steps implementing the main functions of the method of the invention are summarized hereinafter.

The processing method consists in analyzing at the level of a data link layer 2 of the router R the data of the traffic from the different networks that reach a physical layer 1 via each of its connections Li, determining configuration data for the network layer 3 concerned from the network traffic data, and configuring the network layer concerned on the basis of the configuration data and as a function of the traffic of each network.

The invention is not limited to the embodiments of a processing device, a communication router and a processing method described hereinabove by way of example only, but encompasses all variants thereof that the person skilled in the art might envisage that fall within the scope of the following claims.

1. A method of processing data for a communication router having a layered architecture comprising at least one physical layer connected by at least one connection to at least one communication network and placed immediately under at least one data link layer in turn placed immediately under at least one network layer, which method comprises: i) analyzing at the level of a data link layer data traffic from each network reaching a physical layer via each of its connections, ii) determining configuration data for said network layer concerned from said network traffic data, and iii) configuring said network layer concerned on the basis of said configuration data as a function of said traffic of each network.

2. The method claimed in claim 1, wherein said configuration is effected by transferring said configuration data to said network layer concerned via at least one application programming interface between said data link layer and said network layer and independent of each network technology.

3. The method claimed in claim 1, wherein data depending on each network technology implemented by said data link layer concerned is determined from said network traffic data information, after which said information data is converted into configuration data independent of each network technology.

4. The method claimed in claim 3, wherein said network traffic data reaching said physical layer via each of its network connections is observed independently and information data depending on the network technology associated with each network connection is extracted from said traffic data.

5. The method claimed in claim 4, wherein the extracted information data corresponding to each traffic is bundled and the bundled information data is made to conform to a selected format.

6. The method claimed in claim 5, wherein said bundled and conformed information data is converted into configuration data independent of each network technology.

7. The method claimed in claim 1, wherein said traffic data is analyzed periodically so that each network layer may be configured periodically.

8. The method claimed in claim 2, wherein said traffic data is analyzed periodically so that each network layer may be configured periodically.

9. The method claimed in claim 3, wherein said traffic data is analyzed periodically so that each network layer may be configured periodically.

10. The method claimed in claim 1, wherein said traffic data is analyzed on receiving a dedicated notification on one of said connections.

11. The method claimed in claim 2, wherein said traffic data is analyzed on receiving a dedicated notification on one of said connections.

12. The method claimed in claim 3, wherein said traffic data is analyzed on receiving a dedicated notification on one of said connections.

13. The method claimed in claim 1, wherein said configuration data is selected from the group comprising one or more maximum transmission unit sizes, network layer protocol versions used in each network to which a physical layer of the router is connected, network layer service versions used in each network to which a physical layer of said router is connected, and network layer addresses of routers adjacent said router to which a physical layer is connected.

14. The method claimed in claim 2, wherein said configuration data is selected from the group comprising one or more maximum transmission unit sizes, network layer protocol versions used in each network to which a physical layer of the router is connected, network layer service versions used in each network to which a physical layer of said router is connected, and network layer addresses of routers adjacent said router to which a physical layer is connected.

15. The method claimed in claim 3, wherein said configuration data is selected from the group comprising one or more maximum transmission unit sizes, network layer protocol versions used in each network to which a physical layer of the router is connected, network layer service versions used in each network to which a physical layer of said router is connected, and network layer addresses of routers adjacent said router to which a physical layer is connected.

16. The method claimed in claim 13, wherein said protocol versions are selected from the group comprising IPv4, IPv6 and Decnet.

17. The method claimed in claim 13, wherein said service versions are selected from the group comprising the routing protocols.

18. The method claimed in claim 16, wherein said service versions are selected from the group comprising the routing protocols.

19. A data processing system for a communication router having a layered architecture comprising at least one physical layer connected by at least one connection to at least one communication network and placed immediately under at least one data link layer which is itself placed immediately under at least one network layer, which system comprises processing means implemented in each data link layer and adapted to analyze traffic data from each network reaching a physical layer via each of its connections and to determine configuration data for configuring the network layer concerned from said network traffic data, and at least one application programming interface between the data link layer concerned and the network layer concerned, independent of each network technology and adapted to transfer said particular configuration data to said network layer concerned so that it is configured as a function of each network traffic.

20. The system claimed in claim 19, wherein said processing means are adapted to determine information data depending on each network technology implemented by said data link layer concerned from said network traffic data and then to transform said information data into configuration data independent of each network technology.

21. The system claimed in claim 20, wherein said processing means include the same number of surveillance modules as the number of network connections of each physical layer, each surveillance module being adapted to observe said network traffic data reaching said physical layer concerned via one of its network connections and to extract from the latter said information data depending on the network technology associated with said network connection.

22. The system claimed in claim 21, wherein said processing means include the same number of formatting modules as the number of network connections of each physical layer, each formatting module being associated with a surveillance module and adapted to bundle said information data extracted by said associated surveillance module and to conform said bundled information data in accordance with a selected format.

23. The system claimed in claim 22, wherein said processing means comprise a conversion module connected to each formatting module and to said application programming interface concerned and adapted to convert said bundled and conformed information data into configuration data independent of each network technology.

24. The system claimed in claim 19, wherein said processing means are adapted to perform said analysis periodically so that said network layer may be configured periodically.

25. The system claimed in claim 19, wherein said processing means are adapted to analyze said traffic data on receiving a dedicated notification on one of said connections.

26. The system claimed in claim 19, wherein said configuration data is selected from the group comprising one or more maximum transmission unit sizes, network layer protocol versions used in each network to which the physical layer of said router is connected, network layer service versions used in each network to which the physical layer of said router is connected, and network layer addresses of routers adjacent said router to which said physical layer is connected.

27. The system claimed in claim 26, wherein said protocol versions are selected from the group comprising IPv4, IPv6 and Decnet.

28. The system claimed in claim 26, wherein said service versions are selected from the group comprising the routing protocols.

29. The system claimed in claim 27, wherein said service versions are selected from the group comprising the routing protocols.

30. A communication router comprising the processing system claimed in claim 19.

31. Use of the processing device, the communication router and the processing method claimed in claim 19 in Internet Protocol communication networks.
